(19) United States
(12) Patent Application Publication
(10) Pub. No.: US 2022/0088784 A1
(43) Pub. Date: Mar. 24, 2022

(54) Method and Apparatus for Monitoring Robot System

(71) Applicant: ABB Schweiz AG, Baden (CH)

(72) Inventors: Jiajing Tan, Shanghai (CN); Wenyao Shao, Shanghai (CN); Shaojie Cheng, Shanghai (CN)

(73) Assignee: ABB Schweiz AG, Baden (CH)

(21) Appl. No.: 17/419,497

(22) PCT Filed: Jan. 21, 2019
(86) PCT No.: PCT/CN2019/072572

§ 371 Date: Jun. 29, 2021

(51) Int. Cl. B25J 9/16; B25J 9/00; B25J 13/08; B25J 19/02

(52) U.S. Cl. CPC B25J 9/1674; B25J 9/1671; B25J 19/023; B25J 13/089; B25J 9/0093

(57) ABSTRACT

Embodiments of the present disclosure provide methods for monitoring a robot system including a robot arm for processing at least one object. In the method, an arm position of the robot arm may be obtained from a controller of the robot arm. An object position of one of the at least one object may be obtained from object data collected by a camera device. The robot system may be monitored by displaying a virtual representation of the robot arm and a virtual representation of the object based on the obtained arm position and the object position, respectively. Further, embodiments of present disclosure provide apparatuses, systems, and computer readable media for monitoring a robot system. With these embodiments, the robot system may be monitored in an easy and effective way even if the robot system is built in an environment with a narrow place and/or with inadequate light.

### FIELD

Example embodiments of the present disclosure generally relate to a robot system, and more specifically, to methods, apparatuses, systems, and computer readable media, and monitoring systems for monitoring a robot system.

### BACKGROUND

With the development of computer and automatic control, robot systems have been widely used to process various types of objects in the manufacturing industry. Typically, a robot system may have a plurality of mechanical arms, each of which may move within a respective predetermined range. In order to monitor the robot system that performs operations on the object (such as grabbing the object, measuring the size of the object, cut the object to a predetermined shape, etc.), camera devices may be deployed to take images of the object.

There have been proposed several solutions for deploying a camera device and assisting robot system's operation. However, usually the environment of the robot system cannot provide enough space and light for the camera device. Therefore, it is desired to monitor the robot system in a more effective and convenient manner.

### SUMMARY

Example embodiments of the present disclosure provide solutions for monitoring a robot system.

In a first aspect, example embodiments of the present disclosure provide a method for monitoring a robot system comprising a robot arm for processing at least one object.

The method may comprise: obtaining an arm position of the robot arm from a controller of the robot arm; obtaining an object position of one of the at least one object from object data collected by a camera device; and monitoring the robot system by displaying a virtual representation of the robot arm and a virtual representation of the object based on the obtained arm position and the object position, respectively. With these embodiments, the states of the robot arm and the at least one object may be monitoring by displaying virtual representations for the robot arm and the object in a virtual reality environment. With the virtual representations, states of the robot system may be monitored even in a poor environment. Further, these embodiments are particularly suitable for monitoring a robot system located in a narrow place, a place with inadequate light or where a protective cover is placed around the robot system.

In some embodiments of the present disclosure, the robot system further comprises a conveyor on which the at least one object being placed. The method further comprises: obtaining a velocity of movement of the conveyor from a controller of the conveyor; and updating the object position based on the obtained object position and the obtained velocity. Usually, in a manufacturing line, the movement of the conveyor is fast and the object carried on the conveyor may move a non-negligible distance within the time duration from obtaining the image of the object and displaying the virtual representation of the object. With these embodiments, the object position may be updated according to the movement of the conveyor, therefore an accurate state of the object may be displayed, such that the administrator of the robot system may take corresponding actions for controlling the robot system.

In some embodiments of the present disclosure, updating the object position comprises: determining a first time point at which the object data is collected by the camera device; determining a second time point for displaying the virtual representation of the object; and updating the object position based on the obtained velocity and a difference between the determined first and second time points. With these embodiments, the movement of the conveyor is considered during monitoring the robot system, and the virtual representation of the object may be displayed at an updated position that is synchronized with the real position in the real environment of the robot system.

In some embodiments of the present disclosure, monitoring the robot system further comprises: displaying a virtual representation of the conveyor based on the velocity of the movement of the conveyor. With these embodiments, the states of the conveyor are also displayed in the virtual reality environment, such that the administrator may see a whole picture of each component associated with the robot system. Moreover, the displayed virtual representations may facilitate the administrator to discover potential abnormal state of the conveyor and a disharmony between the robot arm and the conveyor.

In some embodiments of the present disclosure, monitoring the robot system further comprises: in response to the object being placed on the conveyor, displaying the virtual representation of the object based on the updated object position. In some embodiments of the present disclosure, monitoring the robot system further comprises: in response to the object being held by the robot arm, displaying the virtual representation of the object based on the arm position and an offset between the object and the robot arm.

During the operations of the robot system, the object is carried on the conveyor and moved near the robot arm for being processed. With these embodiments, a relative position of the object and the conveyor is considered for displaying the object in an accurate position. When the object is placed on the conveyor, the virtual object is displayed on the virtual conveyor; and when the object leaves the conveyor, the virtual object may be picked up by the robot arm. Accordingly, the virtual representations are synchronized with the real environment.

In some embodiments of the present disclosure, monitoring the robot system further comprises: determining a field of view for monitoring the robot system; in response to the object being moved into the field of view with the movement of the conveyor, displaying the virtual representation of the object. It is to be understood that the robot system may occupy a large area in the real environment. While in most instances, the administrator may be interested in only a portion of the area, for example, an area reachable by the robot arm. Considering displaying all the area may be an impractical requirement, a field of view targeted at the interested area may be defined, and only items within the field of view are displayed. With these embodiments, the administrator may define desired one or more field of views for monitoring a specific item in the robot system.

In some embodiments of the present disclosure, the robot arm processes the object according to a processing pattern for defining a manner for processing the at least one object by the robot arm. The processing pattern comprises: a destination position to which the robot arm places the object. With these embodiments, the processing pattern provides more flexibility for controlling the robot system. Accordingly, the robot arm may process the object according to the defined processing pattern.

In some embodiments of the present disclosure, the camera device comprises a distance measurement camera, and the object data comprises a distance between the object and the camera device; and obtaining the object position comprises: obtaining the object position based on the distance and a position of the camera device. With these embodiments, the distance between the object and the camera device maybe accurately measured by a distance measurement sensor in the distance measurement camera.

In some embodiments of the present disclosure, the camera device comprises an image camera, and the object data comprises an image collected by the camera device, and obtaining the object position comprises: obtaining the object position based on a position of the camera device and an image processing of the collect image. 3D cameras are equipped with the distance measurement sensor, and 2D cameras usually only provide the function for capturing images. These embodiments provide solutions for determining the object position based on an image processing of the collect image, therefore cheaper 2D cameras may be utilized for determining the object position.

In a second aspect, example embodiments of the present disclosure provide an apparatus for monitoring a robot system. The apparatus comprises: a first obtaining unit configured to obtain an arm position of the robot arm from a controller of the robot arm; a second obtaining unit configured to obtain an object position of one of the at least one object from object data collected by a camera device; and a monitoring unit configured to monitor the robot system by displaying a virtual representation of the robot arm and a virtual representation of the object based on the obtained arm position and the object position, respectively.

In some embodiments of the present disclosure, the robot system further comprises a conveyor on which the at least one object being placed, the apparatus further comprises: a velocity unit configured to obtain a velocity of movement of the conveyor from a controller of the conveyor; and an updating unit configured to update the object position based on the obtained object position and the obtained velocity.

In some embodiments of the present disclosure, the updating unit comprises: a first time unit configured to determine a first time point at which the object data is collected by the camera device; a second time unit configured to determine a second time point for displaying the virtual representation of the object; and a position updating unit configured to update the object position based on the obtained velocity and a difference between the determined first and second time points.

In some embodiments of the present disclosure, the monitoring unit further comprises: a displaying unit configured to display a virtual representation of the conveyor based on the velocity of the movement of the conveyor.

In some embodiments of the present disclosure, the monitoring unit further comprises: a display unit configured to, in response to the object being placed on the conveyor, display the virtual representation of the object based on the updated object position.

In some embodiments of the present disclosure, the monitoring unit further comprises: a view unit configured to determine a field of view for monitoring the robot system; a displaying unit configured to, in response to the object being moved into the field of view with the movement of the conveyor, display the virtual representation of the object.

In some embodiments of the present disclosure, the monitoring unit further comprises: a displaying unit configured to, in response to the object being held by the robot arm, display the virtual representation of the object based on the arm position and an offset between the object and the robot arm.

In some embodiments of the present disclosure, the robot arm processes the object according to a processing pattern for defining a manner for processing the at least one object by the robot arm. The processing pattern comprises: a destination position to which the robot arm places the object.

In some embodiments of the present disclosure, the camera device comprises a distance measurement camera, and the object data comprises a distance between the object and the camera device; and the first obtaining unit is configured to obtain the object position based on the distance and a position of the camera device.

In some embodiments of the present disclosure, the camera device comprises an image camera, and the object data comprises an image collected by the camera device, and the first obtaining unit is configured to obtain the object position based on a position of the camera device and an image processing of the collect image.

In a third aspect, example embodiments of the present disclosure provide a system for monitoring a robot system. The system comprises: a computer processor coupled to a computer-readable memory unit, the memory unit comprising instructions that when executed by the computer processor implements the method for monitoring a robot system according to a first aspect of the present disclosure.

In a fourth aspect, example embodiments of the present disclosure provide a computer readable medium having instructions stored thereon, the instructions, when executed on at least one processor, cause the at least one processor to perform the method for monitoring a robot system according to a first aspect of the present disclosure.

In a fifth aspect, example embodiments of the present disclosure provide a robot monitoring system. The robot system comprises: a robot system; and an apparatus for monitoring the robot system according to a second aspect of the present disclosure.

### DESCRIPTION OF DRAWINGS

FIG. 1 illustrates a schematic diagram of a robot system that comprises a robot arm for processing at least one object;

FIG. 2 illustrates a schematic diagram for monitoring a robot system in which embodiments of the present disclosure may be implemented;

FIG. 3 illustrates a flowchart of a method for monitoring a robot system in accordance with embodiments of the present disclosure;

FIG. 4 illustrates a schematic diagram for obtaining an object position in accordance with embodiments of the present disclosure;

FIG. 5 illustrates a schematic diagram for obtaining an object position in accordance with embodiments of the present disclosure;

FIG. 6 illustrates a schematic diagram for determining an updated object position of an object that is carried on a conveyor in accordance with embodiments of the present disclosure;

FIG. 7 illustrates a schematic diagram of operations of a robot system in accordance with embodiments of the present disclosure;

FIG. 8 illustrates a schematic diagram of an apparatus for monitoring a robot system in accordance with embodiments of the present disclosure; and

FIG. 9 illustrates a schematic diagram of a system for monitoring a robot system in accordance with embodiments of the present disclosure.

Throughout the drawings, the same or similar reference symbols are used to indicate the same or similar elements.

### DETAILED DESCRIPTION OF EMBODIEMTNS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

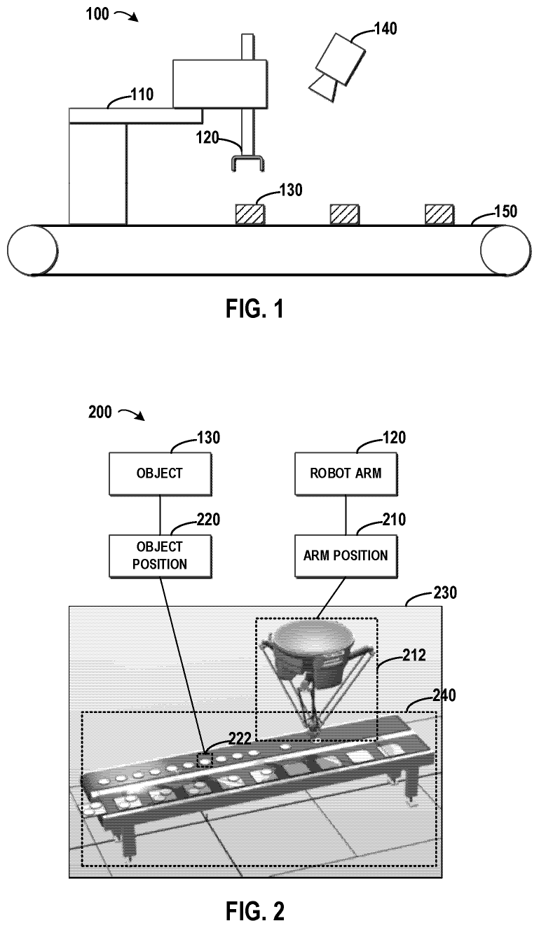

For the sake of description, reference will be made to FIG. 1 to provide a general description of environment of a robot system. FIG. 1 illustrates a schematic diagram of a robot system 100. In FIG. 1, the robot system 100 may comprise: a robot 110 having a robot arm 120 for processing at least one object 130, and a conveyor 150 for carrying the at least one object 130 to positions near the robot arm 120.

In order to monitor operations of the robot system 100, there have been proposed solutions. In those solutions, camera device(s) 140 may be deployed for capturing images and/or videos of the robot system 100. However, in a real manufacturing environment, the robot system 100 is usually deployed in a limited space, and it is difficult to deploy a camera device at a position with an appropriate angle of view. Further, in the real manufacturing environment, due to safety reasons or health reasons, protective cover(s) may be deployed around the robot system 100, which creates more obstacles for the monitoring. In addition, there may be other factors such as insufficient light or occlusion between components in the robot system 100. All of the above will affect the monitoring effect of the camera device 140 and make it difficult for the administrator of the robot system 100 to know real operations of the robot system 100. Accordingly, it is desired to propose a new solution for monitoring the robot system 100 and displaying the states of the robot arm 120 and the object 130 that is to be processed by the robot arm 120.

In order to at least partially solve the above and other potential problems, a new method for monitoring the robot system 100 is disclosed according to embodiments of the present disclosure. In general, according to embodiments of the present disclosure, an arm position of the robot arm 120 and an object position of the object 130 may be obtained. Virtual representations for the robot arm 120 and the object 130 may be generated and displayed at the obtained arm position and the object position in a virtual environment. For the sake of simplicity, the virtual representation of the robot arm 120 may be referred to as a virtual arm 212, and the virtual representation of the object 130 may be referred to as a virtual object 220.

With the virtual representations, the operations of the robot system 100 may be monitored. Here, the virtual representations may be 3D models of the robot arm 120 and the object 130. The arm position and the object position may be continuously obtained in real time, such that a real time animation indicating the operations of the robot system 100 may be displayed. Here, states of the robot system 100 may be monitored even in a poor environment. Accordingly, these embodiments are particularly suitable for monitoring a robot system located in a narrow place, a place with inadequate light or where a protective cover is placed around the robot system.

Reference will be made to FIG. 2 for more details about how to monitor the robot system 100. FIG. 2 illustrates a schematic diagram 200 for monitoring the robot system 100 in which embodiments of the present disclosure may be implemented. In FIG. 2, during operations of the robot system 100, a virtual environment 230 showing operations of the robot arm 120 and the object 130 may be displayed. As shown in FIG. 2, an arm position 210 of the robot arm 120 may be obtained. For example, the arm position 210 may be obtained from a controller of the robot arm 120 in real time. The arm position 210 may be used to determine the arm position 210 at which the virtual arm 212 is displayed.

An object position 220 of one of the at least one object 130 may be determined from object data collected by the camera device 140. In these embodiments, the camera device 140 is used for determining the object position 220 of the object 130, instead of capturing and providing videos of the whole robot system 100 to the administrator of the robot system 100. Here, the camera device 140 may be deployed near the position where the robot arm 120 picks up the object 130. The virtual arm 212 may be displayed at the arm position 210, and the virtual object 222 may be determined at the object position 220. As the arm position 210 and the object position 220 may be continuously obtained, a real time display of the virtual environment 230 may be provided to the administrator for monitoring the robot system 100.

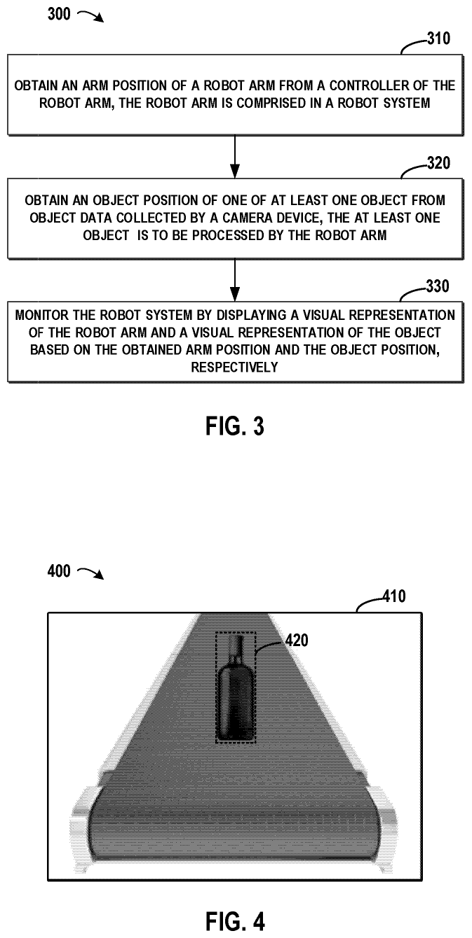

Details of the present invention will be provided with reference to FIG. 3, which illustrates a flowchart of a method 300 for monitoring the robot system 100 in accordance with embodiments of the present disclosure. FIG. 3 illustrates a flowchart of the method 300 for monitoring the robot system 100 in accordance with embodiments of the present disclosure.

At a block of 310, the arm position 210 of the robot arm 120 may be obtained from the controller of the robot arm 120. The arm position 210 may be represented by an arm coordinate system of the robot arm 120. Alternatively, the arm position 210 may be represented by a robot coordinate system of the robot system 100.

At a block of 320, an object position 220 of one of the at least one object 130 may be obtained from object data collected by the camera device 140. In these embodiments, the camera device 140 may be deployed near the robot arm 120 for capturing images of the object 130. Various types of camera devices 140 may be selected in these embodiments. It is to be understood that, beside the common function for capturing images, 3D cameras may be equipped with a distance measurement sensor. With this sensor, a distance between the camera and the object may be directly measured. However, for 2D cameras such as ordinary cameras, they can only capture images, and thus the images should be processed for determining the position of the object 130.

Reference will be made to FIG. 4 for describing how to determine the object position 220 of the object 130 by using an ordinary camera. FIG. 4 illustrates a schematic diagram 400 for obtaining an object position from an image captured by an ordinary camera in accordance with embodiments of the present disclosure. In FIG. 4, an image 410 may be captured by the ordinary camera, and the image 410 may include an object 420 carried on a conveyor. Based on an image recognition technology, the object 420 may be identified from the image 410. Various methods may be utilized for identifying the object 420, for example, a reference image of the to-be-identified object may be provided in advance. By comparing the reference image with the image 410, the area which includes the object 420 may be identified from the image 410. As shown in FIG. 4, if the robot system 100 is for picking up bottle(s) carried on the conveyor 150 into a box, then the reference image may be an image of the bottle.

Once the object 420 is identified from the image 410, the distance between the object 420 and the camera may be determined. For example, the number of pixels within the area of the object 420 and the number of pixels of the image 410 may be used to determine the distance. Alternatively, more complicated algorithms may be utilized to determine the distance. With the distance of between the object 420 and the camera device 140, the object position 220 may be determined. These embodiments provide solutions for determining the object position 220 based on an image processing of the collected image 410, therefore ordinary and cheaper cameras may be utilized for determining the object position 220. It is to be understood that, although the above paragraphs describe multiple positions that may be represented in different coordinate systems, these positions may be converted into a world coordinate system based on respective converting matrixes.

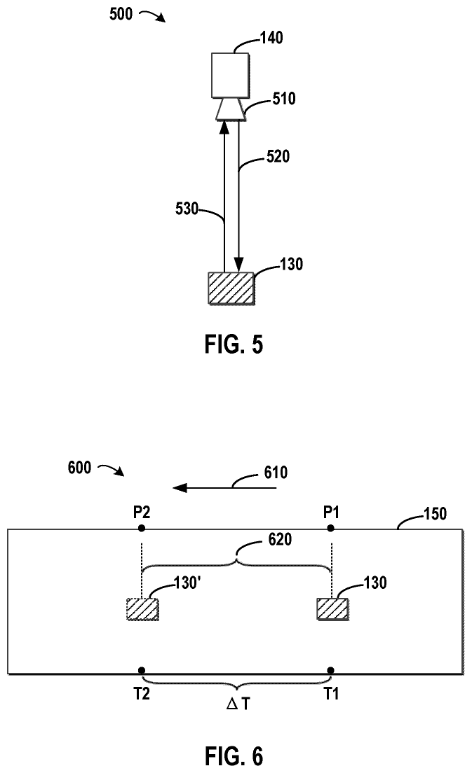

In some embodiments of the present disclosure, a 3D camera equipped with a distance measure sensor may be utilized for determining the object position 220, and reference will be made to FIG. 5 for description. FIG. 5 illustrates a schematic diagram 500 for obtaining the object position 220 by a distance measurement sensor equipped in the camera device 140. As shown in FIG. 5, the camera device 140 may include the distance measurement sensor 510. During operations of the camera device 140, the sensor 510 may transmit a signal 520 (such as a laser beam) towards the object 130. The signal 520 may reach the object 130 and then a signal 530 may be reflected by the object 130. The sensor 510 may receive the reflected signal 530 and determine the distance between the camera device 140 and the object 130 based on a time duration between time points for transmitting the signal 520 and receiving the signal 530.

With these embodiments, the distance between the object 130 and the camera device 140 maybe accurately measured by the distance measurement sensor 510. As the distance measurement sensor 510 greatly increases the cost of the camera device 140, these embodiments are more suitable for precision manufacture lines with high requirements for simulation accuracy.

Referring back to FIG. 3, at a block of 330, the robot system 100 may be monitored by displaying the virtual representation of the robot arm 120 and a virtual representation of the object 130 based on the obtained arm position 210 and the object position 220, respectively. In these embodiments, the arm position 210 may be represented in the robot coordinate system and the object position 220 may be represented in the object coordinate system. In order to provide the virtual representations, the arm position 210 and the object 220 may be converted from their local coordinates into the world coordinate system via corresponding converting matrixes. Further, the virtual arm 212 and the virtual object 222 may be displayed in the virtual environment 230.

With these embodiments, the states of the robot arm 120 and the at least one object 130 may be monitoring by displaying virtual representations for the robot arm and the object in a virtual reality environment. Especially, states of the robot system may be monitored even in a poor environment within a narrow place, a place with inadequate light or where a protective cover is placed around the robot system.

Usually, in a manufacturing line, the movement of the conveyor 150 is fast and the object 130 carried on the conveyor 150 may pass a non-negligible distance within the time duration from obtaining the image of the object 130 and displaying the virtual object 222. In some embodiments of the present disclosure, the robot system 100 further comprises the conveyor 150 on which the at least one object 130 being placed. At this point, the object 130 may move along with the conveyor 150.

In order to provide a whole picture of the robot system 100, a virtual representation of the conveyor (also referred to as the virtual conveyor 240) may be displayed in the virtual environment 230. A velocity of movement of the conveyor 150 may be obtained from a controller of the conveyor 150. Here, the velocity may be represented in the conveyor coordinate system. As the object 130 moves along with the conveyor 150, the object position 220 should be updated based on the obtained object position and the obtained velocity. With these embodiments, the object position 220 may be updated according to the movement of the conveyor 150, therefore the accurate state of the object 130 may be displayed, such that the administrator of the robot system 100 may take corresponding actions for controlling the robot system 100.

In some embodiments of the present disclosure, the virtual conveyor 240 of the conveyor 150 may be displayed in the virtual environment 230 based on the velocity of the movement of the conveyor 150. For example, in the virtual environment 230, the virtual conveyor 240 may move with the rotation of driving shafts of the conveyor 150, and the virtual object 222 placed on the virtual conveyor 240 may move along with the virtual conveyor 240. With these embodiments, the states of the conveyor 150 are also displayed in the virtual reality environment, such that the administrator may see a whole picture of each component associated with the robot system 100. Moreover, the displayed virtual representations may facilitate the administrator to discover potential abnormal state of the conveyor 150 and a disharmony between the robot arm 120 and the conveyor 150.

In some embodiments of the present disclosure, a first time point at which the object data is collected by the camera device 140 may be determined. During operations of the camera device 140, a timestamp may be generated to indicate the time point when the image is captured. Then, the image may be processed to determine the object position 220 when the image is captured. It is to be understood that the conveyor 140 may move a distance before the virtual object 222 is displayed in the virtual environment 230. According, a second time point for displaying the virtual object 222 of the object 130 may be determined to estimate how long the object 130 moves along with the conveyor 150 in the real environment.

Further, based on a time difference between the first and second time points and the velocity, the distance of the movement of the object 130 may be determined. With these embodiments, the movement of the conveyor 150 is considered in monitoring the robot system 100, and the virtual object 222 may be displayed at an updated position that is synchronized with the real position in the real environment. Accordingly, the administrator may know the accurate states of the object 130, therefore further control to the robot system 100 may be implemented on a reliable base.

Reference will be made to FIG. 6 for details about how to update the object position 220, which figure illustrates a schematic diagram 600 for determining an updated object position of the object 130 that is carried on the conveyor 150 in accordance with embodiments of the present disclosure. As shown in FIG. 6, the object 130 is placed on the conveyor 150. At a time point T1, the object 130 is located at a position P1. As the conveyor 150 is moving from the right to the left (as shown by an arrow 610) at a velocity V, the object 130 will reach a position P2 between the time points T1 and T2 (at which time point the virtual object 222 will be displayed in the virtual environment 230). Based on the geometry relationship shown in FIG. 6, the object 130 will move a distance 620, and the distance 620 may be determined as V*(T2−T1). Therefore, the updated object position may be determined as

P2=P1+V*(T2−T1) Equation 1

Based on the above Equation 1, the updated object position may be determined for each position P1 that is obtained from each image taken by the camera device 140. Therefore, an animation indicating the movement of the virtual object 222 along with the virtual conveyor 240 may be displayed in the virtual environment 230.

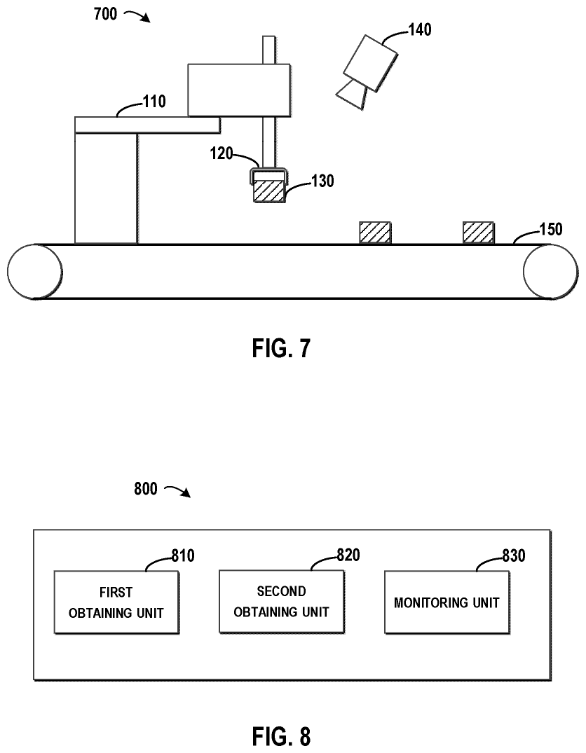

FIG. 7 illustrates a schematic diagram 700 of operations of the robot system 100 in accordance with embodiments of the present disclosure. As shown in FIG. 7, in a real environment, the object 130 is placed on the conveyor 150 and be moved to an area near the robot arm 120. At this point, the object 130 moves along with the conveyor 150. Afterwards, the robot arm 120 may pick up the object 130 and placed the object 130 to a predefined destination position. Accordingly, displaying the virtual object 222 may relate to two situations: 1) the object 130 is placed on the conveyor 150; and 2) the object 130 is held by the robot arm 120.

In some embodiments of the present disclosure, if the object 130 is placed on the conveyor 150, the virtual object 222 may be displayed based on the updated object position as determined according to Equation 1. If the object 130 is held by the robot arm 120, then the virtual object 222 may be displayed based on the arm position 210 and an offset between the object 130 and the robot arm 120. With these embodiments, a relative position of the object 130 and the conveyor 150 is considered for displaying the virtual object 222 in an accurate position. Accordingly, the virtual representations are synchronized with the real environment.

In some embodiments of the present disclosure, the offset between the object 130 and the robot arm 120 may be determined from the object data that is collected from the camera device 140. As both of the robot arm 120 and the object 130 may be identified from the image captured by the camera device 140, therefore the offset may be estimated. In another example, if the distance measurement sensor is equipped in the camera device 140, the point cloud data for both the robot arm 120 and the object 130 may be obtained, and then a more accurate offset may be determined. With these embodiments, the relative positions between the robot arm 120 and the object 130 may be determined accurately, which is suitable for monitoring a robot system with high requirements for simulation accuracy.

In some embodiments of the present disclosure, the offset may be determined based on a dimension of the object 130 and the robot arm 120. In addition to and/or alternatively, the offset may be a predetermined value. With these embodiments, the offset may be determined in a relatively simple way, and thus it is particularly suitable for a robot system where the requirement for the simulation accuracy is low.

It is to be understood that the robot system 100 may occupy a large area in the real environment, and the administrator may be interested in only a portion of the area. Considering displaying all the area may result in high costs in processing resources, a field of view may be defined. Accordingly, in some embodiments of the present disclosure, a field of view may be defined for monitoring the robot system 100. Here, only items within the field of view may be displayed while other items which are outside of the field of view may be omitted. The field of view may be defined in advance by the administrator of the robot system 100. Here, the field of view may correspond to one three dimension window in the virtual environment 230. If the object 130 moves into the field of view with the movement of the conveyor 150, the virtual object 222 may be displayed. With these embodiments, the administrator may define desired the field of view for monitoring a specific item in the robot system 100.

In some embodiments of the present disclosure, one or more field of views may be defined. For example, one field of view may be used to closely monitor the operations of robot arm 120 for picking up the object 130. Meanwhile, another field of view may be used to monitor the operations of the conveyor 150 for transporting the object 130. With these embodiments, each field of view may correspond to a window in the virtual environment 230. By switching among these windows, the virtual environment 230 may provide rich information of all the items in the robot system 100.

In some embodiments of the present disclosure, the robot arm 120 may process the object 130 according to a processing pattern for defining a manner for processing the at least one object by the robot arm. Based on functions of the robot system 100, various processing patterns may be defined for the robot system 100. In one example, the processing pattern may define a destination position to which the robot arm 120 places the object 130. In a manufacturing line for packaging bottles on the conveyor 150 into boxes, the destination position may be a location of the box. Further, the processing pattern may define how to package the bottles. For example, it may define that every six bottles should be packaged into one box. In a manufacturing line for cutting raw workpieces into desired shapes, the processing pattern may define a path of the robot arm 120 or other parameters for controlling the robot arm 120. With these embodiments, the processing pattern provides more flexibility for controlling the robot system 100. Accordingly, the robot arm 120 may process the object 130 according to the defined processing pattern.

In some embodiments of the present disclosure, an apparatus 800 for monitoring a robot system 110 is provided. FIG. 8 illustrates a schematic diagram of the apparatus 800 for monitoring a robot system 110 in accordance with embodiments of the present disclosure. As illustrated in FIG. 8, the apparatus 800 may comprise: a first obtaining unit 810 configured to obtain an arm position of the robot arm from a controller of the robot arm; a second obtaining unit 820 configured to obtain an object position of one of the at least one object from object data collected by a camera device; and a monitoring unit 830 configured to monitor the robot system by displaying a virtual representation of the robot arm and a virtual representation of the object based on the obtained arm position and the object position, respectively.

In some embodiments of the present disclosure, the robot system further comprises a conveyor on which the at least one object being placed, the apparatus 800 further comprises: a velocity unit configured to obtain a velocity of movement of the conveyor from a controller of the conveyor; and an updating unit configured to update the object position based on the obtained object position and the obtained velocity.

In some embodiments of the present disclosure, the updating unit comprises: a first time unit configured to determine a first time point at which the object data is collected by the camera device; a second time unit configured to determine a second time point for displaying the virtual representation of the object; and a position updating unit configured to update the object position based on the obtained velocity and a difference between the determined first and second time points.

In some embodiments of the present disclosure, the monitoring unit 830 further comprises: a displaying unit configured to display a virtual representation of the conveyor based on the velocity of the movement of the conveyor.

In some embodiments of the present disclosure, the monitoring unit 830 further comprises: a display unit configured to, in response to the object being placed on the conveyor, display the virtual representation of the object based on the updated object position.

In some embodiments of the present disclosure, the monitoring unit 830 further comprises: a view unit configured to determine a field of view for monitoring the robot system; a displaying unit configured to, in response to the object being moved into the field of view with the movement of the conveyor, display the virtual representation of the object.

In some embodiments of the present disclosure, the monitoring unit 830 further comprises: a displaying unit configured to, in response to the object being held by the robot arm, display the virtual representation of the object based on the arm position and an offset between the object and the robot arm.

In some embodiments of the present disclosure, the robot arm processes the object according to a processing pattern for defining a manner for processing the at least one object by the robot arm. The processing pattern comprises: a destination position to which the robot aim places the object.

In some embodiments of the present disclosure, the camera device comprises a distance measurement camera, and the object data comprises a distance between the object and the camera device; and the first obtaining unit is configured to obtain the object position based on the distance and a position of the camera device.

In some embodiments of the present disclosure, the camera device comprises an image camera, and the object data comprises an image collected by the camera device, and the first obtaining unit is configured to obtain the object position based on a position of the camera device and an image processing of the collect image.

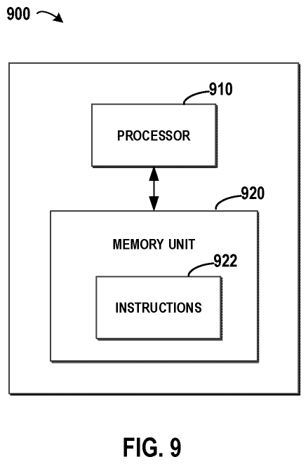

In some embodiments of the present disclosure, a system 900 for monitoring a robot system is provided. FIG. 9 illustrates a schematic diagram of the system 900 for monitoring a robot system 110 in accordance with embodiments of the present disclosure. As illustrated in FIG. 9, the system 900 may comprise a computer processor 910 coupled to a computer-readable memory unit 920, and the memory unit 920 comprises instructions 922. When executed by the computer processor 910, the instructions 922 may implement the method for monitoring a robot system as described in the preceding paragraphs, and details will be omitted hereinafter.

In some embodiments of the present disclosure, a computer readable medium for monitoring a robot system is provided. The computer readable medium has instructions stored thereon, and the instructions, when executed on at least one processor, may cause at least one processor to perform the method for monitoring a robot system as described in the preceding paragraphs, and details will be omitted hereinafter.

In some embodiments of the present disclosure, a robot monitoring system is provided. The robot system comprises: a robot system; and an apparatus for monitoring the robot system according to the present disclosure.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIG. 3. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. On the other hand, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for monitoring a robot system, the robot system comprising a robot arm for processing at least one object, the method comprising:
obtaining an arm position of the robot arm from a controller of the robot arm;
obtaining an object position of one of the at least one object from object data collected by a camera device; and
monitoring the robot system by displaying a virtual representation of the robot arm and a virtual representation of the object based on the obtained arm position and the object position, respectively.

2. The method of claim 1, wherein the robot system further comprises a conveyor on which the at least one object is placed, the method further comprising:
obtaining a velocity of movement of the conveyor from a controller of the conveyor; and
updating the object position based on the obtained object position and the obtained velocity.

3. The method of claim 2, wherein updating the object position comprises:
determining a first time point at which the object data is collected by the camera device;
determining a second time point for displaying the virtual representation of the object; and
updating the object position based on the obtained velocity and a difference between the determined first and second time points.

4. The method of claim 3, wherein monitoring the robot system further comprises:
displaying a virtual representation of the conveyor based on the velocity of the movement of the conveyor.

5. The method of claim 3, wherein monitoring the robot system further comprises:
in response to the object being placed on the conveyor, displaying the virtual representation of the object based on the updated object position.

6. The method of claim 1, wherein monitoring the robot system further comprises:
determining a field of view for monitoring the robot system; and
in response to the object being moved into the field of view with the movement of the conveyor, displaying the virtual representation of the object.

7. The method of claim 3, wherein monitoring the robot system further comprises:
in response to the object being held by the robot arm, displaying the virtual representation of the object based on the arm position and an offset between the object and the robot arm.

8. The method of claim 2, wherein the robot arm processes the object according to a processing pattern for defining a manner for processing the at least one object by the robot arm, and the processing pattern comprises:
a destination position to which the robot arm places the object.

9. The method of claim 1, wherein the camera device comprises a distance measurement camera, and the object data comprises a distance between the object and the camera device; and
obtaining the object position comprises: obtaining the object position based on the distance and a position of the camera device.

10. The method of claim 1, wherein the camera device comprises an image camera, and the object data comprises an image collected by the camera device, and
obtaining the object position comprises: obtaining the object position based on a position of the camera device and an image processing of the collect image.

11. An apparatus for monitoring a robot system, the robot system comprising a robot arm for processing at least one object, the apparatus comprising:
a first obtaining unit configured to obtain an arm position of the robot arm from a controller of the robot arm;
a second obtaining unit configured to obtain an object position of one of the at least one object from object data collected by a camera device; and
a monitoring unit configured to monitor the robot system by displaying a virtual representation of the robot arm and a virtual representation of the object based on the obtained arm position and the object position, respectively.

12. The apparatus of claim 11, wherein the robot system further comprises a conveyor on which the at least one object is placed, the apparatus further comprises:
a velocity unit configured to obtain a velocity of movement of the conveyor from a controller of the conveyor; and
an updating unit configured to update the object position based on the obtained object position and the obtained velocity.

13. The apparatus of claim 12, wherein the updating unit comprises:
a first time unit configured to determine a first time point at which the object data is collected by the camera device;
a second time unit configured to determine a second time point for displaying the virtual representation of the object; and
a position updating unit configured to update the object position based on the obtained velocity and a difference between the determined first and second time points.

14. The apparatus of claim 13, wherein the monitoring unit further comprises:
a displaying unit configured to display a virtual representation of the conveyor based on the velocity of the movement of the conveyor.

15. The apparatus of claim 13, wherein the monitoring unit further comprises:
a display unit configured to, in response to the object being placed on the conveyor, display the virtual representation of the object based on the updated object position.

16. The apparatus of claim 11, wherein the monitoring unit further comprises:
a view unit configured to determine a field of view for monitoring the robot system;
a displaying unit configured to, in response to the object being moved into the field of view with the movement of the conveyor, display the virtual representation of the object.

17. The apparatus of claim 13, wherein the monitoring unit further comprises:
a displaying unit configured to, in response to the object being held by the robot arm, display the virtual representation of the object based on the arm position and an offset between the object and the robot arm.

18. The apparatus of claim 12, wherein the robot arm processes the object according to a processing pattern for defining a manner for processing the at least one object by the robot arm, and the processing pattern comprises:
a destination position to which the robot arm places the object.

19. The apparatus of claim 11, wherein the camera device comprises a distance measurement camera, and the object data comprises a distance between the object and the camera device; and
the first obtaining unit is configured to obtain the object position based on the distance and a position of the camera device.

20. The apparatus of claim 11, wherein the camera device comprises an image camera, and the object data comprises an image collected by the camera device, and
the first obtaining unit is configured to obtain the object position based on a position of the camera device and an image processing of the collect image.

21. A system for monitoring a robot system, the robot system comprising a robot arm for processing at least one object, the robot system comprising: a computer processor coupled to a computer-readable memory unit, the memory unit comprising instructions that when executed by the computer processor implements a method comprising:
obtaining an arm position of the robot arm from a controller of the robot arm;
obtaining an object position of one of the at least one object from object data collected by a camera device; and
monitoring the robot system by displaying a virtual representation of the robot arm and a virtual representation of the object based on the obtained arm position and the object position, respectively.

22. A computer readable medium having instructions stored thereon, the instructions, when executed on at least one processor, cause the at least one processor to perform a method for monitoring a robot system, the robot system comprising a robot arm for processing at least one object, the method comprising:
obtaining an arm position of the robot arm from a controller of the robot arm;
obtaining an object position of one of the at least one object from object data collected by a camera device; and
monitoring the robot system by displaying a virtual representation of the robot arm and a virtual representation of the object based on the obtained arm position and the object position, respectively.

23. A robot monitoring system, comprising:
a robot system comprising a robot arm for processing at least one object; and
an apparatus for monitoring the robot system comprising:
a first obtaining unit configured to obtain an arm position of the robot arm from a controller of the robot arm;
a second obtaining unit configured to obtain an object position of one of the at least one object from object data collected by a camera device; and
a monitoring unit configured to monitor the robot system by displaying a virtual representation of the robot arm and a virtual representation of the object based on the obtained arm position and the object position, respectively.
